(19) United States
(12) Patent Application Publication
(10) Pub. No.: US 2024/0101779 A1
(43) Pub. Date: Mar. 28, 2024

(54) HIGH-PERFORMANCE FOAM STRUCTURE BASED ON GRAPHENE WITH EXCELLENT ACOUSTICAL PROPERTIES AND THEIR USE AS ACOUSTICAL INSULATION MATERIAL

(71) Applicant: Braskem S.A., Camaçari (BR)

(72) Inventors: Mauro Alfredo Soto Oviedo, São Paulo (BR); Cristina Saiz-Arroyo, Valladolid (ES); Miguel Angel Rodriguez-Perez, Valladolid (ES)

(73) Assignee: Braskem S.A., Camaçari (BR)

(21) Appl. No.: 18/374,135

(22) Filed: Sep. 28, 2023

Related U.S. Application Data
(60) Provisional application No. 63/411,064, filed on Sep. 28, 2022.

(51) Int. Cl. C08J 9/10; C08J 3/205; C08K 3/04

(52) U.S. Cl. CPC C08J 9/103; C08J 3/2056; C08K 3/042; C08J 2201/024; C08J 2203/04; C08J 2205/052; C08J 2323/08; C08J 2331/04; C08K 2201/006

(57) ABSTRACT

A polymer-based foam composition includes an ethylene-based polymer matrix, graphene particles dispersed in the matrix, at least one crosslinking agent, at least one blowing agent, and optionally, kickers, crosslinking co-agents, plasticizers or combinations thereof. The polymer-based foam composition is particularly useful for applications that require lightweight and sound insulation properties.

### BACKGROUND

The automotive industry is looking for technologies to decrease the weighting in building cars and trucks to achieve fuel economy improvement and greenhouse gas emission control.

Seals for steering dust covers used in the automotive industry today are based on EPDM, NBR, NR, SBR, TPU materials which generally have substantially high densities.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A polymer-based foam including graphene particles and having a substantially lower density than the presently-used products is disclosed. The polymer-based foam including graphene particles may provide densities about 2 to 4 times lower than those of the traditional products while fulfilling technical criteria.

In one aspect, embodiments disclosed herein relate to a polymer-based foam composition comprising an ethylene-based polymer, graphene particles dispersed in the ethylene-based polymer, at least one crosslinking agent, at least one blowing agent, and optionally, kickers, crosslinking co-agents, plasticizers or combinations thereof.

In another aspect, embodiments disclosed herein relate to a method of preparation of a foam comprising expanding the polymer-based foam composition of one or more embodiments of the present invention to produce the foam.

In a further aspect, embodiments disclosed herein relate to a foam prepared according to the method of one or more embodiments of the present invention.

In a further aspect, embodiments disclosed herein relate to articles comprising the foam of one or more embodiments of the present invention and use of said foams for manufacturing of seals steering dust covers or as acoustic insulation material.

### BRIEF DESCRIPTION OF DRAWINGS

FIG. 1 shows nominal densities of the EVA-graphene foamed samples in accordance with one or more embodiments.

FIG. 2 shows relative densities of the EVA-graphene foamed samples in accordance with one or more embodiments.

FIG. 3 shows normal incidence acoustic absorption coefficients of the EVA-graphene foamed samples in accordance with one or more embodiments.

FIGS. 4A-4R show stress-strain curves corresponding to the first and fifth compression cycles for (a) ultra-low-density foams, (b) Low density foam, and (c) medium density prototypes, in accordance with one or more embodiments.

FIGS. 5A-5B show compression test results for the EVA-graphene foamed samples in accordance with one or more embodiments.

### DETAILED DESCRIPTION

Embodiments disclosed herein generally relate to a polymer-based foam composition comprising an ethylene-based polymer (ethylene-based polymer matrix, polymer matrix), dispersed graphene particles in the polymer matrix, at least a crosslinking agent, at least a blowing agent, and optionally, kickers, crosslinking co-agents, plasticizers and combinations thereof.

In one or more embodiments, the ethylene-based polymer includes low density polyethylene, high density polyethylene, linear low density polyethylene, copolymers of ethylene and one or more C3-C20 alpha olefins, ethylene vinyl acetate copolymer, ethylene methyl acrylate copolymer, ethylene butyl acrylate copolymer, ethylene-propylene copolymers, ethylene-propylene diene copolymer, thermoplastic ethylene elastomers, metallocene polymers, polyolefin elastomers, vulcanized thermoplastic elastomers or styrenic block copolymers, chlorinated derivatives thereof.

In one or more embodiments, the ethylene-based polymer is a copolymer comprising ethylene, vinyl acetate and optionally a third comonomer, having from 20 to 90 wt. % of vinyl acetate and a melt flow index ranging from 2 to 150 g/10 min measured according to ASTM D1238 (190° C./2.16 kg).

In one or more embodiments, the ethylene-based polymer includes virgin resins, plastic waste, such as post consumed resins, post-industrial resins, scraps, etc, and combinations thereof. In one or more embodiments, the polymer is obtained from a fossil-based or biobased source, or combinations thereof.

In one or more embodiments, the graphene may be present in an amount ranging from 0.01 to 10 phr, or 0.1 to 5 phr in the polymer-based foam composition. In one or more embodiments, the graphene presents at least one of the following properties (i) a carbon content equal or higher than 90%, (ii) an average specific area ranging from 80 to 200 m²/g, an (iii) average lateral size ranging from 0.1 to 3.0μ, (iv) a crystalline size from 0.1 to 100 μm and (v) a number of layers from 1 to 10. The graphene may present all properties (i) to (v). The graphene may have a crystalline size from 0.1 to 100 μm and a number of layers from 1 to 5.

The crosslinking agent of one or more embodiments of the present invention may include organic peroxides, in an amount ranging from 0.3 to about 4 phr.

The organic peroxide may be one or more organic peroxides that will effectively at least partially crosslink the ethylene-based polymer. Exemplary organic peroxides include diacyl peroxides, such as, for example decanoyl peroxide, lauroyl peroxide, succinic acid peroxide, and benzoyl peroxide; dialkyl peroxides, such as for example dicumyl peroxide, 2,5-di(t-butylperoxy)-2,5-dimethylhexane, t-butyl cumyl peroxide, α,α-bis(t-butylperoxy)diisopropylbenzene, di(t-amyl)peroxide, di(t-butyl)peroxide, and 2,5-di(t-butylperoxy)-2,5-dimethyl-3-hexyne; diperoxyketals, such as for example 1,1-di(t-butylperoxy)-3,3,5-trimethylcyclohexane, 1,1-di(t-butylperoxy)cyclohexane, 1,1-di(t-amylperoxy)-cyclohexane, n-butyl-4,4-di(t-amylperoxy)valerate, ethyl-3,3-di(t-amylperoxy)butanoate, t-butyl-peroxy-2-ethylhexanoate, and ethyl-3,3-di(t-butylperoxy)butyrate; hydroperoxides, such as for example cumene hydroperoxide and t-butyl hydroperoxide; ketone peroxides, such as for example methyl ethyl ketone peroxide and 2,4-pentanedione peroxide; peroxydicarbonates, such as for example di(n-propyl)peroxydicarbonate, di(sec-butyl)peroxydicarbonate, and di(2-ethylhexyl)peroxydicarbonate; and peroxyesters, such as for example 3-hydroxy-1,1-dimethylbutyl peroxyneodecanoate, α-cumyl peroxyneodecanoate, t-amyl peroxyneodecanoate, t-butyl peroxyneodecanoate, t-amyl peroxypivalate, t-butyl peroxypivalate, 2,5-di(2-ethylhexanoylperoxy)-2,5-dimethylhexane, t-amyl peroxy-2-ethylhexanoate, t-butyl peroxy-2-ethylhexanoate, t-amyl peroxyacetate, t-butyl peroxyacetate, t-butyl peroxybenzoate, OO-(t-amyl)-O-(2-ethylhexyl)monoperoxycarbonate, OO-(t-butyl)-O-isopropyl monoperoxycarbonate, OO-(t-butyl)-O-(2-ethylhexyl)monoperoxycarbonate, polyether poly-t-butylperoxy carbonate, and t-butyl peroxy-3,5,5-trimethylhexanoate. The foregoing list is not intended to be exhaustive, and any organic peroxide that will facilitate crosslinking of the ethylene-based polymer to produce the desired results is within the spirit and scope of one or more embodiments of the present invention. In certain embodiments, the organic peroxide may be 2,5-di(t-butylperoxy)-2,5-dimethyl-3-hexyne or 2,5-di(t-butylperoxy)-2,5-dimethylhexane.

In one or more embodiments, BIBP [Bis(t-butylperoxy isopropyl)benzene] is used in one-step expansion process (e.g. for producing medium density foams). In one or more embodiments, DCP (Dicumyl peroxide) is used in a two-step expansion process (e.g. for producing low-density foams).

In one or more embodiments of the present invention, crosslinking co-agents may be used in conjunction with the peroxide initiators. These co-agents may also be used when grafting agents. Various compounds are known to be useful as crosslinking co-agents. Generally, a compound is useful as a crosslinking co-agent if it has at least two groups containing a reactive carbon-carbon double bond in the molecule. Examples of useful crosslinking co-agents include, but are not limited to, aromatic polyfunctional compounds such as divinylbenzene, diallyl phthalate, diallyl isophthalate, 4-4′-isopropylidenedipehol bis(diethyleneglycolmethacrylate)ether, triallyltrimellitate, and 2,2′-bis(4-acryloxy diethoxyphenyl)propane, aliphatic polyfunctional compounds such as syn-1,2-pulybutadiene, 1,4-butanediol diacrylate, N,N′-methylenebisacrylamide, ethylene glycol dimethacrylate, neopentyl glycol dimethacrylate, trimethylolpropane trimethacrylate, 1,6-hexanediol diacrylate, diethylene glycol dimethacrylate, triethylene glycol dimethacrylate, 1,6-hexanediol dimethacrylate, and tetrahexanediol dimethacrylate, alicylic polyfunctional compounds such as triallyl isocyanurate, trallyl cyanurate, triacrylohexahydro-1,3,5-triazine, and diacryl chlorendate, metal-containing polyfunctional compounds such as aluminum acrylate, aluminum methacrylate, zinc acrylate, zinc methacrylate, magnesium acrylate, magnesium methacrylate, calcium acrylate, calcium methacrylate, zircon acrylate, and zircon methacrylate.

The blowing agent used in the composition of one or more embodiments of the present invention includes chemical or physical blowing agents, organic or inorganic blowing agents and combinations thereof. The blowing agent is present in an amount ranging from 2 to 10 phr.

Blowing agents in accordance with the present disclosure may include chemical blowing agents that decompose at polymer processing temperatures, releasing the blowing gases such as N₂, CO, CO₂, and the like. Examples of chemical blowing agents may include organic blowing agents, including hydrazines such as toluenesulfonyl hydrazine, hydrazides such as oxydibenzenesulfonyl hydrazide, diphenyl oxide-4,4′-disulfonic acid hydrazide, and the like, nitrates, azo compounds such as azodicarbonamide, cyanovaleric acid, azobis(isobutyronitrile), and N-nitroso compounds and other nitrogen-based materials, and other compounds known in the art.

Inorganic chemical blowing agents may include carbonates such as sodium hydrogen carbonate (sodium bicarbonate), sodium carbonate, potassium bicarbonate, potassium carbonate, ammonium carbonate, and the like, which may be used alone or combined with weak organic acids such as citric acid, lactic acid, or acetic acid.

As mentioned, the polymer-based foam composition of one or more embodiments of the present invention optionally comprises kickers for blowing agent decomposition that may include Zinc Oxide (ZnO), Zinc Stearate (ZnSt) and combinations thereof. In one or more embodiments, a combination of ZnO and ZnSt may be used to produce medium density foams in one-step expansion process and ZnSt in the case of low-density foams in two-steps process.

The polymer-based foam compositions according to one or more embodiments of the present invention may optionally comprise additives including fillers, processing aids (e.g. stearic acid), lubricants, antistatic agents, clarifying agents, nucleating agents, beta-nucleating agents, slipping agents, antioxidants, compatibilizers, antacids, light stabilizers, IR absorbers, whitening agents, inorganic fillers, organic and/or inorganic dyes, anti-blocking agents, flame-retardants, plasticizers, biocides, adhesion-promoting agents, metal oxides, mineral fillers, glidants, oils, anti-oxidants, antiozonants, accelerators, vulcanizing agents, or combinations thereof.

The polymer-based compositions in accordance with the present disclosure may include one or more inorganic fillers such as talc, glass fibers, marble dust, cement dust, clay, carbon black, feldspar, silica or glass, fumed silica, silicates, calcium silicate, silicic acid powder, glass microspheres, mica, metal oxide particles and nanoparticles such as magnesium oxide, antimony oxide, zinc oxide, inorganic salt particles and nanoparticles such as barium sulfate, wollastonite, alumina, aluminum silicate, titanium oxides, calcium carbonate, polyhedral oligomeric silsesquioxane (POSS), or recycled EVA. As defined herein, recycled EVA may be derived from regrind materials that have undergone at least one processing method such as molding or extrusion and the subsequent sprue, runners, flash, rejected parts, and the like, are ground or chopped.

In another aspects, one or more embodiments of the present invention relate to a method of preparation of a foam comprising expanding the polymer-based foam composition. The expanding may occur in a one-step or two-step expansion (also referred as double-step expansion).

In one or more embodiments, prior to the expanding the polymer-based foam composition to produce a foam, such as ethylene-based polymer/graphene foam, the graphene particles are pre-dispersed in the ethylene-based polymer (polymeric matrix). In one or more embodiments, the graphene particles are added to the ethylene-based polymer and mixed with 1000 ppm of polyethylene glycol, and this mixture is introduced to a twin extruder to exfoliate and disperse the graphene particles in the polymer matrix using high shear rate and high retention time. This concentrate is subsequently diluted in the copolymer in a subsequent melting mixing step until the obtainment of the desired concentration. Melt mixing steps may occur in Banbury mixer chamber or extruder. In one or more embodiments, the masterbatch presents from 5 to 30 wt. % of dispersed graphene.

The foams of one or more embodiments of the present invention may present a nominal density ranging from 20 to 200 kg/m³.

By using one or more embodiments of the present invention method, it is possible to obtain an ultra-low-density foam with relative densities lower than 0.05. or 0.03, a low-density foam with relative densities lower than 0.1, or 0.05, or a medium-density foam with relative densities lower than 0.15 or 0.1.

Low and ultra-low-density foams show higher values of loss factor indicating that these two types of materials exhibit a higher dampening capability than medium density foams. In low density and specially in medium density foams, graphene particles induce an increment of the loss factor thus increasing the vibration dampening capacity of the materials.

The foams of one or more embodiments of the present invention present closed cell structure or partially closed cell structure having higher than 50% of closed cells.

The foams of one or more embodiments of the present invention present a higher normal incidence acoustic absorption coefficient below 2500 Hz. The foams of one or more embodiments of the present invention present an absorption coefficient in the range of about 0.2 to about 1.0, and a damping loss factor in the range of about 0.3 to about 1.0.

Foams of one or more embodiments of the present invention are particularly useful in applications that required lightweight and sound insulation properties.

Therefore, the foams may be used in seals for steering dust covers and car parts in general. The foams may be used to reduce noise transmission to the interior of the vehicle through the front-of-dash panel. The analysis of the mechanical and acoustic properties of these materials shows that the foams present features such that the foams are feasible for replacing the current materials used as seals for steering dust covers in the automotive industry.

The foams of one or more embodiments of the present invention are especially advantageous for use as acoustic insulation material.

However, the outstanding properties shown by the foams of one or more embodiments make them especially attractive for several types of applications.

Therefore, one or more embodiments of the present invention are related to articles comprising the polymer-based composition. Said articles may include, but are not limited to, automotive parts (such as dampening elements, crash pads, thermoformed parts), sports goods (such as shoe soles, yoga mats, clothing, protective elements), carpet underlays and packaging, in sound insulating systems, seals for steering dust covers, etc.

### EXAMPLES

### Production of Foam Based on Graphene and Eva

EVA-based compositions according to one or more embodiments were prepared as follows.

The EVA used is a commercial EVA having a Melt Index of 7 g/10 min measured according to ASTM D 1238 (190° C./2.16 Kg), vinyl acetate content of 28 wt. % based on the EVA copolymer, density of 0.950 g/cm³ measured according to D 1505/D 793, environmental stress cracking resistance higher than 300 h/F50 measured according to D 1693, hardness of 80/25 Shore A/D measured according to D 2240, melting point of 77° C. measured according to D 3418 and a Vicat softening temperature at 10 N of 49° C. measured according to D 1525.

The graphene used presents a Carbon Content: >95% Average Specific Area: 100-140 m²/g and Average Lateral Size: 1-2μ.

The samples were prepared with concentrations of graphene in EVA of 0, 0.5 and 1.0 phr.

For the preparation of the samples, graphene powder was pre-dispersed in the EVA forming a masterbatch composition with a concentration of 10% (w/w) of graphene. The pre-dispersion was performed by melt mixing in a twin extruder.

The graphene masterbatch was then diluted in the EVA to form the EVA-based foam composition using a Banbury mixer chamber with addition of crosslinking agents, blowing agents, kickers and processing aids.

The crosslinking agents utilized were BIBP (Bis(t-butylperoxy isopropyl)benzene) in the case of the one-step process (medium density foams) and DCP (Dicumyl peroxide) in the case of low-density foams (two-steps process).

The blowing agent used was Azodicarbonamide (average particle size 8 microns, same grade for all the materials).

The kickers used for blowing agent decomposition were a combination of ZnO and ZnSt in the case of medium density foams (one step process) and ZnSt in the case of low-density foams (two-steps process).

The processing aid used was Stearic acid (same grade in both cases).

The formulations are shown in Table 1.

TABLE 1
Formulations

| | Sample ULD-0 | Sample ULD-0.5 | Sample ULD-1 |
|---|---|---|---|
| Component | (phr) | (phr) | (phr) |
| EVA | 100 | 100 | 100 |
| DCP | 0.8 | 0.7 | 0.8 |
| Azodicarbonamide | 18 | 18 | 18 |
| ZnSt | 0.1 | 0.1 | 0.1 |
| Stearic Acid | 0.5 | 0.5 | 0.5 |
| Graphene | 0 | 0.5 | 1 |

The EVA-based composition foam composition was then expanded in a one-step or two-step process using a compression press. The process conditions are shown in Table 2.

TABLE 2
Process conditions

| | | |
|---|---|---|
| 1st Foaming Step | Temperature (° C.) | 152 |
| | Time (min) | 45 |
| 2nd Foaming Step | Temperature (° C.) | 180 |
| | Time (min) | 50 |

Table 3 indicates the production route of each sample as well as obtained nominal and relative densities.

TABLE 3
EVA samples production routes and densities.

| | Graphene | Nominal | | |
|---|---|---|---|---|
| | concentra- | Density | Production | |
| Samples | tion (phr) | (kg/m³) | Route | Relative densities |
| ULD-0 G | 0 | 30 | Two-Steps C.M. | Ultra-low-density |
| ULD-0.5 G | 0.5 | 30 | Two-Steps C.M. | foams with |
| ULD-1.0 G | 1.0 | 30 | Two-Steps C.M. | relative densities |
| | | | | lower than 0.05 |
| | | | | (0.03) |
| LD-0 G | 0 | 50 | Two-Steps C.M. | Low-density foams |
| LD-0.5 G | 0.5 | 50 | Two-Steps C.M. | with relative |
| LD-1.0 G | 1.0 | 50 | Two-Steps C.M. | densities lower |
| | | | | than 0.1 (0.05) |
| MD-0 G | 0 | 150 | One-Step C.M. | Medium-density |
| MD-0.5 G | 0.5 | 150 | One-Step C.M. | foams with |
| MD-1.0 G | 1.0 | 150 | One-Step C.M. | relative densities |
| | | | | higher than 0.1 (0.15) |

### Density Analysis

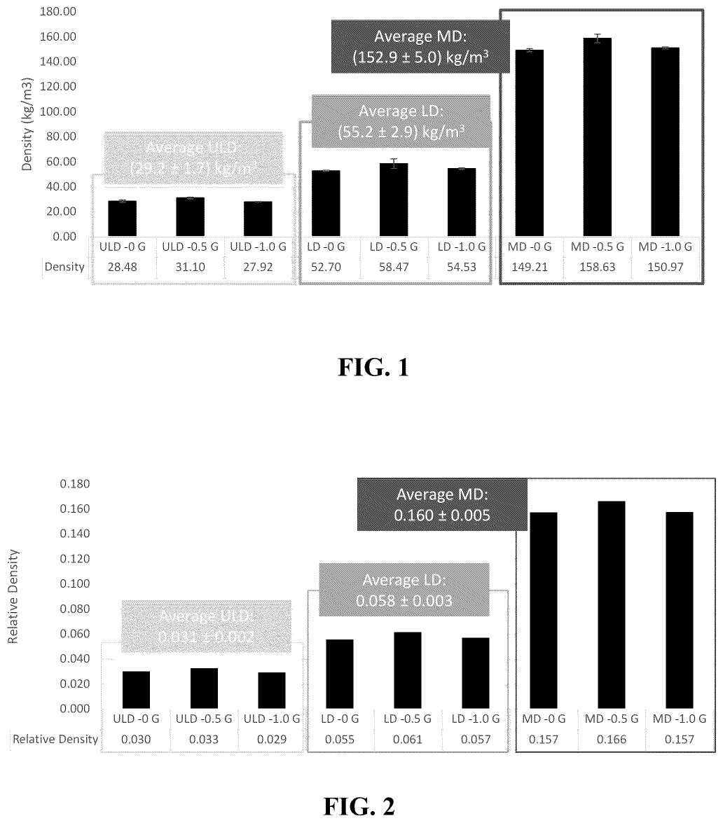

The graph shown in FIG. 1 presents the average density values of the three different sets of prototypes. The ultra-low density materials present a nominal density of around 30 kg/m³ while that of the low-density ones is around 50 kg/m3 and for the medium-density around 150 kg/m³.

The graph shown in FIG. 2 displays the relative density values of the different samples. Relative density corresponds to the ratio between the density of the foam and the density of the corresponding solid. This parameter is typically employed in foams to compare between materials produced out of different solids. In this case, it is possible to observe that in the three density ranges, the prototypes present very similar relative densities making their further comparison easier.

### Acoustic Performance

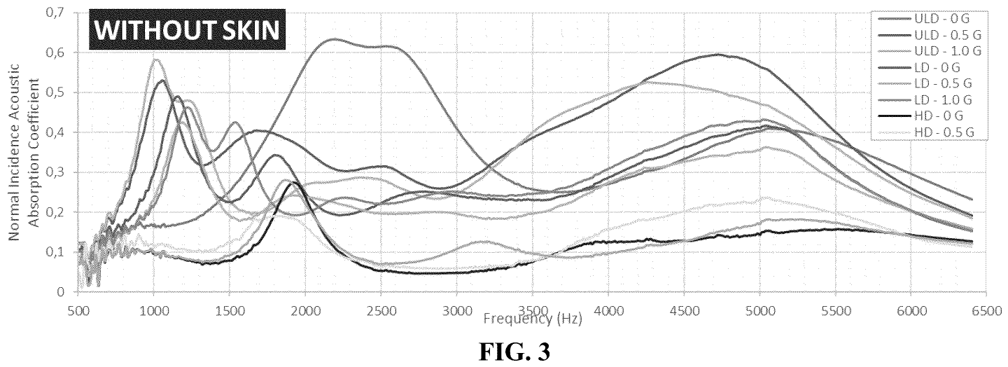

The curves of FIG. 3 show the typical shape of closed cell foams (or partially open cell foams) displaying local maximum values at specific frequencies.

For most of the materials the local maximum is below 2500 Hz which is the range of interest for the automotive industry.

Due to density reduction, the ultra-low density foams present a higher acoustic absorption capability than the other two types of materials in the whole considered frequency range. In both ultra-low-density foams and medium-density foams, graphene particles help providing a better level of acoustic absorption.

### Mechanical Performance

### Stress-Strain Curves

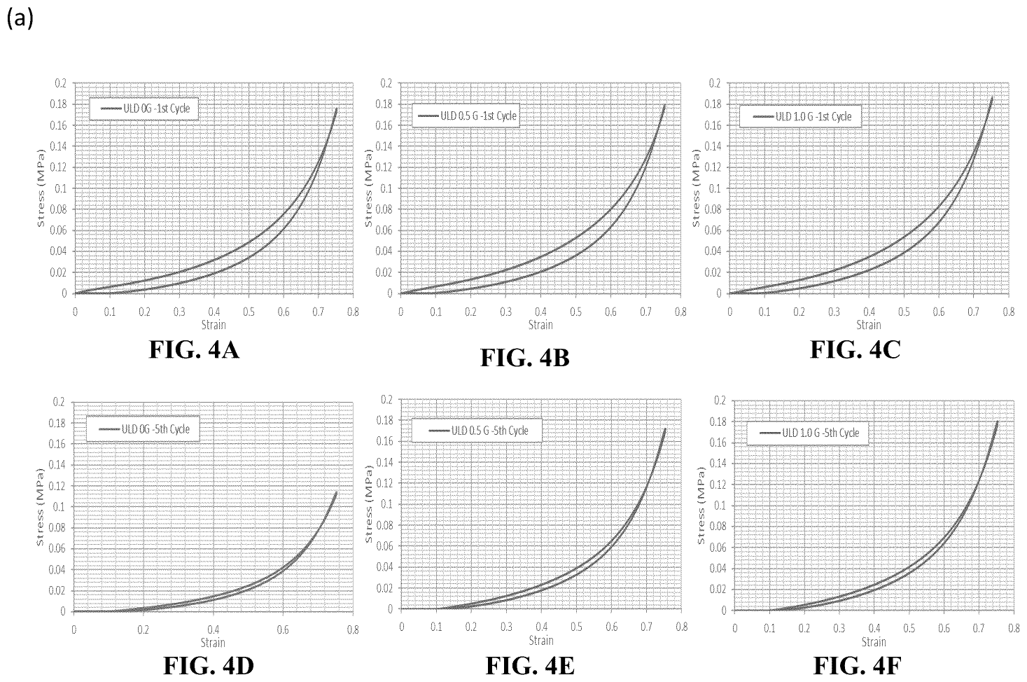

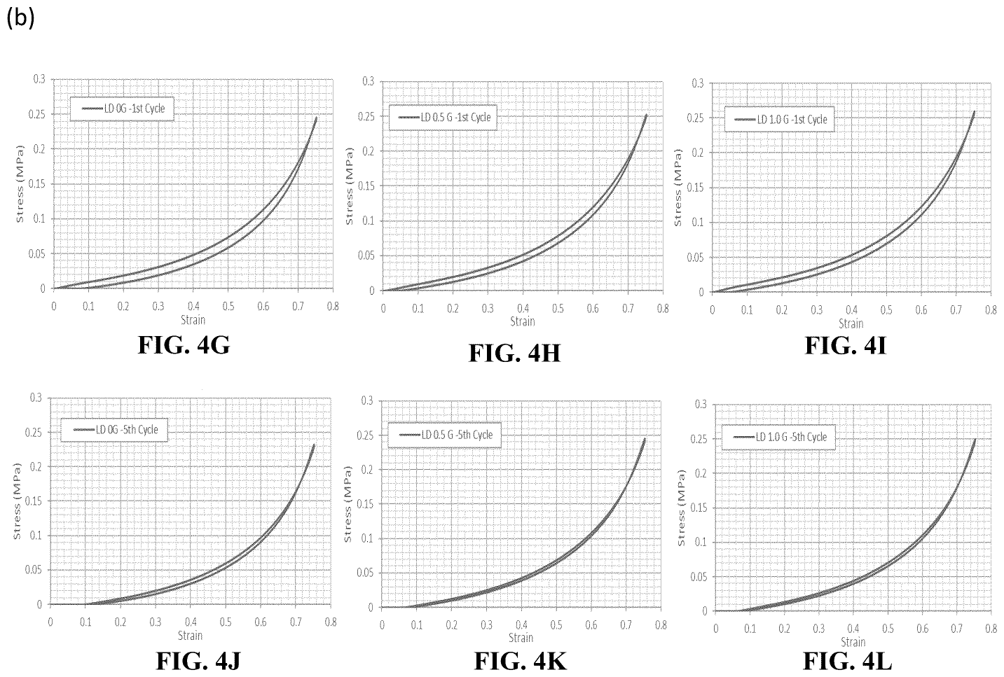

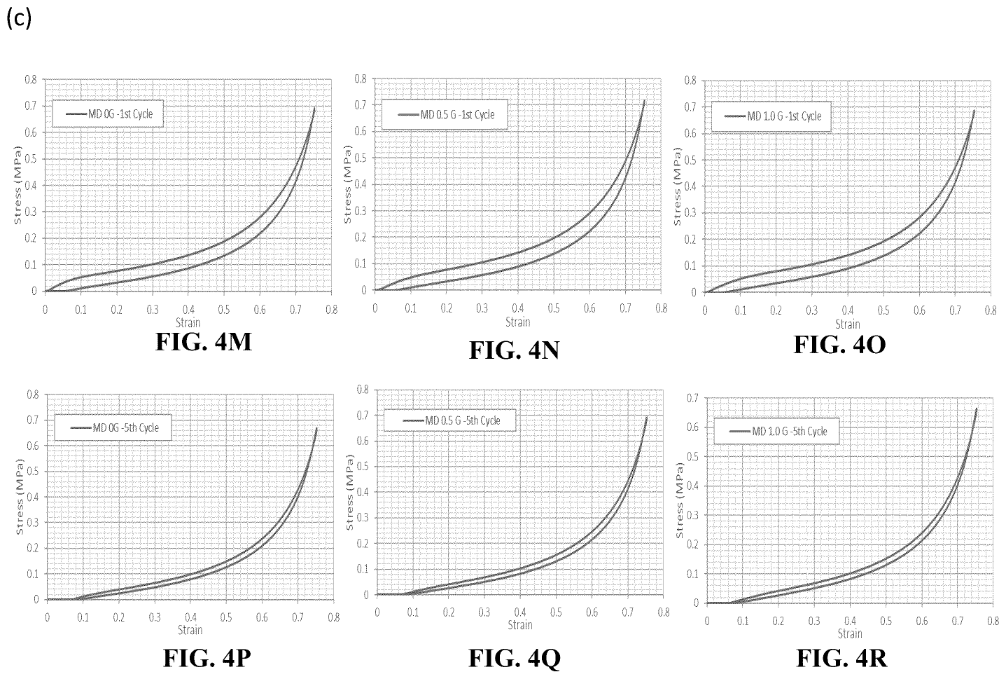

The graphs of FIGS. 4A-4R show the stress-strain curves corresponding to the 1st and 5th compression cycles for (a) ultra-low-density foams (FIGS. 4A-4F), (b) Low density foam (FIGS. 4G-4L), and (c) medium density prototypes (FIGS. 4M-4R).

It is possible to observe that the materials display a very high recovering capability since the unloading curve runs almost overlapped to the loading curve.

The presence of graphene particles seems to contribute to produce materials with better recovering capability. The hysteresis of the materials is even lower when graphene particles are added to the formulation.

Additionally, this effect seems to keep improving with the number of compression cycles at which the materials are subjected.

The recovering capability of the medium density prototypes is still rather good but slightly lower than that of low-density materials. The presence of graphene particles does not seem to have such clear influence in the hysteresis of the materials, and the successive loading cycles contribute to reduce the hysteresis.

### Compression Tests

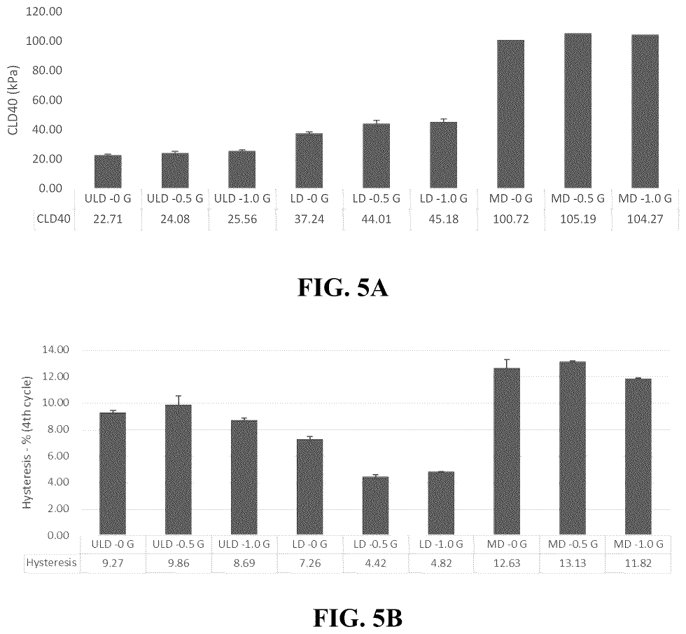

The graphs on FIGS. 5A-5B present two of the most critical parameters characterizing polyurethane foams. The first one relates to stiffness (CV40 defined as the stress at 40% strain in the 4th deformation cycle) and the Hysteresis which is an indicative of the capability to recover after deformation, i.e., the lower this value, the easier the recovery capability.

All the EVA-based samples, including ultra-low-density ones, display CV40 values higher than the two commercial products. The main reason behind this lies in the fact that the EVA foams (either containing graphene or not) are closed cell products and the commercial ones open cell foams.

One possibility to reach lower CV40 values for the EVA-foams could be reducing the density. In fact, the values reached by the EVA foam without graphene are not far from the sample included in Fiesta despite having a much lower density (4 times lower).

The EVA foams produced so far during this study present hysteresis values significantly lower than the two commercial products included for comparative purposes. This means that the recovery capability of the EVA foams made using an EVA grade with a high VA content is better than that of medium density open cell PU foams.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

1. A polymer-based foam composition comprising:
an ethylene-based polymer;
graphene particles dispersed in the ethylene-based polymer;
at least one crosslinking agent;
at least one blowing agent; and
optionally, kickers, crosslinking co-agents, plasticizers or combinations thereof.

2. The polymer-based foam composition according to claim 1, wherein the ethylene-based polymer is at least one selected from the group consisting of low density polyethylene, high density polyethylene, linear low density polyethylene, copolymers of ethylene and one or more C3-C20 alpha olefins, ethylene vinyl acetate copolymer, ethylene methyl acrylate copolymer, ethylene butyl acrylate copolymer, ethylene-propylene copolymers, ethylene-propylene diene copolymer, thermoplastic ethylene elastomers, metallocene polymers, polyolefin elastomers, vulcanized thermoplastic elastomers, styrenic block copolymers, and chlorinated derivatives thereof.

3. The polymer-based foam composition according to claim 1,
wherein:
the ethylene-based polymer is a copolymer comprising ethylene, vinyl acetate and optionally a third comonomer, and
the ethylene-based polymer comprises vinyl acetate in a range of from 20 to 90 wt. %, and has a melt flow index ranging from 2 to 150 g/10 min measured according to ASTM D1238 at 190° C./2.16 kg.

4. The polymer-based foam composition according to claim 1, wherein the ethylene-based polymer is at least one selected from the group consisting of virgin resins, plastic waste comprising at least one selected from the group consisting of post consumed resins, post-industrial resins, and scraps, and an ethylene-based polymer obtained from a fossil-based source, a biobased source, or combinations thereof.

5. The polymer-based foam composition according to claim 1, wherein the graphene particles are present in an amount ranging from 0.01 to 10 phr.

6. The polymer-based foam composition according to claim 1, wherein the graphene particles present at least one of the following properties:
(i) a carbon content equal to or higher than 90%,
(ii) an average specific area ranging from 80 to 200 m²/g,
(iii) an average lateral size ranging from 0.1 to 3.0μ,
(iv) a crystalline size ranging from 0.1 to 100 μm, and
(v) a number of layers ranging from 1 to 10.

7. The polymer-based foam composition according to claim 1, wherein the crosslinking agent comprises organic peroxides in an amount ranging from 0.3 to 4 phr.

8. The polymer-based foam composition according to claim 1, wherein:
the blowing agent is at least one selected from the group consisting of chemical or physical blowing agents, organic or inorganic blowing agents, or combinations thereof, and
the blowing agent is present in an amount ranging from 2 to 10 phr.

9. The polymer-based foam composition according to claim 1, wherein the kickers are at least one selected from the group consisting of zinc oxide, and zinc stearate.

10. The polymer-based foam composition according to claim 1, wherein composition further comprises additives at least one selected from the group consisting of fillers, processing aids, lubricants, antistatic agents, clarifying agents, nucleating agents, beta-nucleating agents, slipping agents, antioxidants, compatibilizers, antacids, light stabilizers, IR absorbers, whitening agents, inorganic fillers, organic and/or inorganic dyes, anti-blocking agents, flame-retardants, plasticizers, biocides, adhesion-promoting agents, metal oxides, mineral fillers, glidants, oils, anti-oxidants, antiozonants, accelerators, and vulcanizing agents.

11. A method of preparation of a foam comprising expanding the polymer-based foam composition according to claim 1 to produce the foam.

12. The method according to claim 11, wherein the expanding occurs in a one-step expansion or a two-step expansion.

13. The method according to claim 11, wherein, prior to the expanding, the graphene particles are pre-dispersed in the ethylene-based polymer by melt mixing.

14. A foam prepared according to the method of claim 11.

15. The foam according to claim 14, wherein the foam presents a nominal density ranging from 20 to 200 kg/m³.

16. The foam according to claim 14, wherein the foam is a ultra-low-density foam with a relative density lower than 0.05, a low-density foam with a relative density lower than 0.1, or a medium-density foam with a relative density lower than 0.15.

17. The foam according to claim 14, wherein the foam presents a closed cell structure or a partially closed cell structure.

18. The foam according to claim 14, wherein the foam presents a higher normal incidence acoustic absorption coefficient below 2500 Hz.

19. The foam according to claim 14, wherein the foam presents an absorption coefficient in a range of 0.2 to 1.0, and a damping loss factor in a range of 0.3 to 1.0.

20. Articles prepared with the foam according to claim 14.

21. The articles according to claim 20, wherein the articles are at least one selected from the group consisting of:
automotive parts comprising at least one selected from the group consisting of dampening elements, crash pads, and thermoformed parts,
sports goods comprising at least one selected from the group consisting of shoe soles, yoga mats, clothing, and protective elements, carpet underlays and packaging,
in sound insulating systems, and
seals for steering dust covers.
